(19) United States
(12) Patent Application Publication
(10) Pub. No.: US 2022/0164844 A1
(43) Pub. Date: May 26, 2022

(54) METHOD AND SYSTEM FOR PROVIDING PRODUCTION AND DISTRIBUTION PLATFORM

(71) Applicant: DONG HA PRECISION CO., LTD., Bucheon-si (KR)

(72) Inventor: Jin Wook KIM, Bucheon-si (KR)

(21) Appl. No.: 17/622,733

(22) PCT Filed: Jul. 1, 2020
(86) PCT No.: PCT/KR2020/008563

§ 371 Date: Dec. 24, 2021

(30) Foreign Application Priority Data
Jul. 9, 2019 (KR) 10-2019-0082515

(51) Int. Cl. G06Q 30/06

(52) U.S. Cl. CPC G06Q 30/0619

(57) ABSTRACT

A method for providing by a server a manufacturing and distribution platform connecting a product buyer and a product seller is provided. The method comprises providing basic disclosed information of multiple sellers to an accessing buyer terminal, receiving information of candidate sellers selected by the buyer terminal, and providing an interface screen of a private chat room which allows the buyer terminal and each candidate seller terminal to exchange manufacturing confidential information related to a product and a company. The private chat room connects the buyer terminal and the candidate sellers one-on-one and each private chat room provided to each of the candidate sellers is maintained or closed according to each step of a contracting procedure set by the buyer terminal.

### TECHNICAL FIELD

The present invention relates to a manufacturing and distribution platform technology.

### BACKGROUND ART

Online to offline (O2O) business is spreading in all industries. As products and services in each field get globalized and supply and demand get diversified, the suppliers and consumers can conveniently supply or buy products or services through O2O platforms.

This is the same as in the manufacturing industry. Manufacturing refers to making elaborate products by adding artificial manipulation in factories on a large scale, and the manufacturing industry refers to an industry that produce new goods by processing raw materials. Manufacturing in the electric/electronic sectors is largely classified into automobiles, equipment machinery, electrical equipment, shipbuilding, medical equipment, mobile phones, home appliances, semiconductors, and PC.

The size of the manufacturing market related to the global electric/electronic sectors reaches above 70% of the total manufacturing market. Although the size of direct manufacturing market in developed countries is shrinking, the size of direct manufacturing market in China, Vietnam, and India is rapidly expanding. Accordingly, large companies or mid-sized companies in developed countries looks for manufacturers that reside in countries leading direct manufacturing from the buyer's point of view and then conclude outsourcing contracts with the manufacturers.

It takes a lot of money and time for the buyer to find a manufacturer having technological prowess and price competitiveness and to accomplish mass production of the product. Generally, the buyer determines a suitable manufacturer based on introduction from the surrounding industry or by obtaining company information through internet search. However, in this case, since there are no documents including information on the parts that can be produced by each manufacturer on general websites, it is very difficult to find a suitable manufacturer through internet. In addition, though the manufacturers spend a lot of time and money in sales, promotion, and marketing activities to find a buyer, very few contracts are concluded with actual buyers. Thus, such activities are not cost-effective from the manufacturers' point of view.

Of course, a conventional platform connecting buyers and manufacturers already exist. However, the conventional platform only provides company information of manufacturers and does not provide confidential information of the corresponding company, such as manufacturing concept of a buyer, sales scale of a manufacturer. Therefore, in order to proceed to conclude an actual contract, the buyer should conduct additional actions, such as sending an additional e-mail or visiting the manufacturer by itself. That is, the conventional platform has a limit in that the buyer and the manufacturer cannot reach the conclusion of a contract using the platform only.

In addition, there are many conventional platforms that connect suppliers and consumers in fields other than manufacturing, such as wholesale and retail, lodging, and real estate brokerage. However, there is a limit in that the conventional platforms are applied only when disclosing information, such as the supply amount and the price desired by the consumer, to a third party does not cause any harm. Since the manufacturing industry has features that drawings of products desired by consumers and the supply amount of the supplier should be kept confidential, it is difficult to utilize the conventional platform as it is.

### DISCLOSURE

### Technical Problem

The problem to be solved is to provide a manufacturing and distribution platform where overall distribution procedure from information exchange to a contract conclusion conducted between a buyer and a seller (a manufacturer) is performed in an online platform and confidential information exchanged between the buyer and the seller is kept security.

### Technical Solution

According to an embodiment, a method for providing by a server a manufacturing and distribution platform connecting a product buyer and a product seller is provided. The method includes providing basic disclosed information of multiple sellers to an accessing buyer terminal, receiving a connection request for candidate sellers selected by the buyer terminal among the multiple sellers, and providing an interface screen of a private chat room which allows the buyer terminal and each candidate seller terminal to exchange manufacturing confidential information related to a product and a company. The private chat room may connect the buyer terminal and the candidate sellers one-on-one, and each private chat room provided to each of the candidate sellers may be maintained or closed according to each step of a contracting procedure set by the buyer terminal.

After providing the interface screen of the private chat room, the server may receive information related to evaluation including a supplier selection check sheet and an evaluation deadline, create an evaluation step notification window on the interface of the private chat room, and block file uploading by the candidate seller terminal and activate a contract signing button when the evaluation deadline is over.

When the buyer terminal selects a contract counterparty seller and concludes a contract, the server may create a contract signing step notification window on a private chat room with the contract counterparty seller, maintain only the private chat room with the contract counterparty seller, and close remaining private chat rooms by inactivating functions of the remaining private chat rooms.

The server may transmit the information related to the evaluation and notices received from the buyer terminal to all private chat rooms created on the buyer terminal at a time.

The server may provide a video conference interface or remote drawing conference interface through the interface screen of the private chat room.

According to another embodiment, a method for providing by a server a manufacturing and distribution platform connecting a product buyer and a product seller is provided. The method includes receiving seller selection criteria from a buyer terminal, selecting candidate sellers among multiple sellers based on the seller selection criteria and basic disclosed information of the multiple sellers, and providing an interface screen of a private chat room which allows the buyer terminal and each candidate seller terminal to exchange manufacturing confidential information related to a product and a company. The private chat room may connect the buyer terminal and the candidate sellers one-on-one, and each private chat room provided to each of the candidate sellers may be maintained or closed according to each step of a contracting procedure set by the buyer terminal.

Providing the interface screen of the private chat room may include giving a score to each candidate seller according to a degree to which the basic disclosed information of the candidate sellers matches the seller selection criteria, and arranging the private chat rooms created on the buyer terminal according to the given scores.

The method may further include receiving evaluation information including a supplier selection check sheet and an evaluation deadline from the buyer terminal, after providing the interface screen of the private chat room. The server may inactivate functions of a chat room with a seller that did not submit materials within the evaluation deadline among the candidate sellers and close the chat room.

When the evaluation deadline is over and the buyer terminal selects a contract counterparty seller, the server may maintain only a private chat room with the contract counterparty seller and close remaining private chat rooms by inactivating functions of the remaining private chat rooms.

According to still another embodiment, a method for providing by a server a manufacturing and distribution platform connecting a product buyer and a product seller is provided. The method includes receiving seller selection criteria from a buyer terminal, selecting primary candidate sellers among multiple sellers based on the seller selection criteria and basic disclosed information of the multiple sellers, providing information of the primary candidate sellers to the buyer terminal, receiving a connection request with secondary candidate sellers selected by the buyer terminal among the primary candidate sellers, and providing an interface screen of a private chat room that allows the buyer terminal and each of the secondary candidate sellers to exchange manufacturing confidential information related to a product and a company. The private chat room may connect the buyer terminal with the secondary candidate sellers one-on-one, and each private chat room provided to each of the candidate sellers may be maintained or closed according to each step of a contracting procedure set by the buyer terminal.

Providing the interface screen of the private chat room may include giving a score to each of the secondary candidate sellers according to a degree to which the basic disclosed information of the secondary candidate sellers matches the seller selection criteria, and arranging the private chat rooms created on the buyer terminal according to the given scores.

After providing the interface screen of the private chat room, the server may receive information related to an evaluation including a supplier selection check sheet and an evaluation period, and when the evaluation is over, the server may maintain only a private chat room with the contract counterparty seller and may close remaining private chat rooms by inactivating functions of the remaining chat rooms.

### ADVANTAGEOUS EFFECTS

According to the present invention, a buyer and a seller can safely share and manage manufacturing confidential information of which security is essential.

In addition, according to the present invention, the buyer can check and compare the characteristics and quotations of multiple sellers without any inconvenience of inquiring the multiple sellers one-on-one via phone or email, and can perform processes from seller evaluation to contract conclusion on a single platform.

### DESCRIPTION OF THE DRAWINGS

FIG. 1 is a diagram illustrating an existing platform that connects a buyer and a seller.

FIG. 2 is a configuration diagram of a system for providing a manufacturing and distribution platform according to an embodiment.

FIG. 3 is a flowchart showing a method for operating a server according to an embodiment.

FIG. 4 is a flowchart showing a method for concluding a contract through a manufacturing and distribution platform according to an embodiment.

FIG. 5 is a flowchart showing a method for concluding a contract through a manufacturing and distribution platform according to another embodiment.

FIG. 6 is a flowchart showing a method for concluding a contract through a manufacturing and distribution platform according to another embodiment.

FIG. 7 is an example diagram of a seller search screen displayed on a buyer terminal according to an embodiment.

FIG. 8 is an example diagram of a screen showing a private chat room list displayed on a buyer terminal according to an embodiment.

FIG. 9 is an example diagram of a screen showing a maintained private chat room according to an embodiment.

FIG. 10 is an example diagram of a screen showing a private chat room that is closed due to not being selected as a seller according to an embodiment.

FIG. 11 is an example diagram of a screen showing a private chat room that is closed due to non-participation of a seller according to an embodiment.

### MODE FOR INVENTION

In the following detailed description, only certain example embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, when a part is referred to “include” a certain element, it means that it may further include other elements rather than exclude other elements, unless specifically indicates otherwise.

In the specification, expressions described in the singular may be interpreted as the singular or plural unless an explicit expression such as “one” or “single” is used.

In the specification, a buyer and a seller (a manufacturer) are parties involved in a manufacturing and distribution process. Specifically, the buyer refers to a party that orders a product to be manufactured in the manufacturing and distribution process, and the seller refers to a party that directly manufactures the product ordered by the buyer. For example, the buyer does not manufacture the product by itself but orders the product to be manufactured in the original equipment manufacturing (OEM) way from the seller. Then, the seller directly manufactures the product ordered by the buyer according to the contract.

In the specification, a terminal may refer to any calculation means that can support collecting, reading, processing, manipulating, storing, and displaying data, such as a desktop computer, a laptop computer, a smart phone, a PDA, or a mobile phone.

Meanwhile, a general contracting process between the buyer and the seller is as follows. Firstly, the buyer and the seller exchange basic disclosed information about each other. Upon completing a preliminary investigation into each other after exchanging the basic disclosed information, the buyer performs an evaluation for selecting a seller. At this time, the buyer provides documents including an evaluation procedure and criteria to the seller, and the seller submits materials including a business registration certificate, a certificate of seal impression, financial statements, a credit report, and the like. When the buyer sets an evaluation deadline, the seller should submit documents within the deadline. If the deadline lapsed without submitting the documents, the seller cannot be selected as a contract counterparty seller.

Meanwhile, the evaluation procedure may be performed using a tender method. At this time, the buyer posts a notice of tender and sellers that want to bid may participate in the tender. In this process, the buyer and sellers share manufacturing confidential information including drawings and quotations. Since the manufacturing confidential information should be kept confidential, it should not be disclosed to a third party other than the concerned parties.

After an evaluation deadline or tender deadline is over, the buyer selects a contract counterparty seller by evaluating quality capability, competitiveness, financial ability, transaction performance, and the like of the sellers based on the information thereof.

The buyer completes the procedure by concluding a contract with the selected contract counterparty seller. The buyer may additionally evaluate development capability and quality control capability for manufacturing products of the contract counterparty seller after concluding the contract.

Hereinafter, a method for providing a manufacturing and distribution platform according to an embodiment of the present invention will be described with reference to the accompanying drawings.

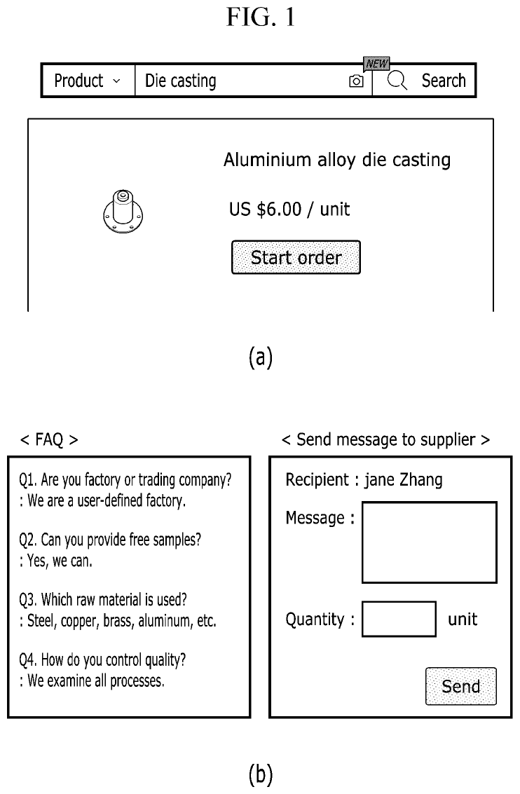

FIG. 1 is a diagram illustrating an existing platform that connects a buyer and a seller.

Referring to (a) of FIG. 1, when a buyer puts “die casting” in a search box of an existing platform, information of pre-registered sellers related to “die casting”, such as seller information, major items, and price information, is displayed. If you click a name of a specific seller in search results, you can find photos and price information of the major items dealt by the seller.

On the other hand, the buyer can read details of sellers and company profiles retrieved through the existing platform. However, to make this possible, the sellers should enter by themselves product details to be fit for a form determined by the existing platform. As a result, the sellers experience the inconvenience of having to re-enter contents of already kept company introduction files. In addition, the form determined by the existing platform is designed to enter confidential information among the seller information, which causes vulnerability in security.

Further, referring to (b) of FIG. 1, a form that allows the buyer to send a message directly to the seller is provided. However, using the form is the same as exchanging e-mails.

Consequentially, the buyer cannot conclude a contract with a seller only based on the information contained in the form determined by the existing platform, and in order to conclude an actual contract the buyer should specify details of the contract through direct communication with the seller. Therefore, it is almost impossible for the buyer and the seller to proceed up to a step of concluding a contract within the existing platform.

Therefore, a technology that enables the buyer to check information on the seller for which the buyer request to manufacture a product, to sign a memorandum of understanding and a non-disclosure agreement, to distribute drawings, to make price bidding on a single platform is required.

When countless sellers from all over the world are registered on the single platform, the buyers and the sellers can be efficiently connected. Thus, new customer and sellers can be found easily. On the other hand, in order to locally perform company introduction and advertisement and marketing of technical skills to the buyer, the seller requires a platform that facilitates finding a buyer locally.

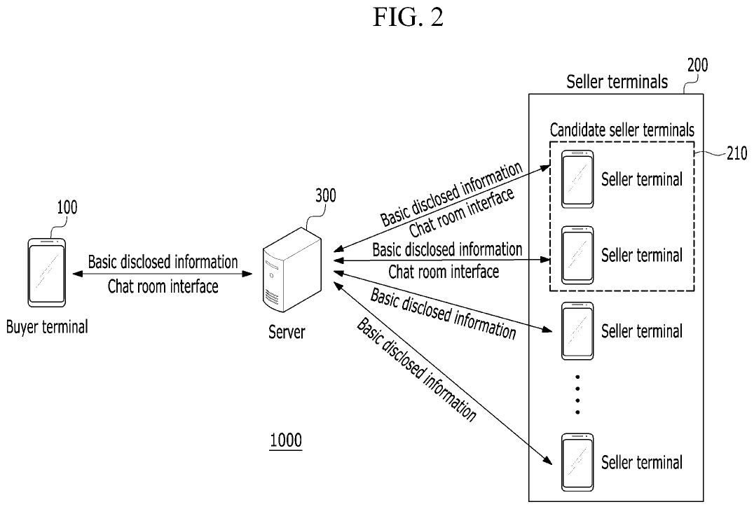

FIG. 2 is a configuration diagram of a system for providing a manufacturing and distribution platform according to an embodiment.

Referring to FIG. 2, a manufacturing and distribution platform providing system 1000 includes a buyer terminal 100, one or more seller terminals 200, and a server 300 to which the buyer terminal 100 and seller terminals 200 access. The terminal is a device that can access the server 300, display an interface screen provided by the server 300, and communicate with the server 300. The server 300 is implemented to provide the interface screen of the manufacturing and distribution platform to the accessing terminals, to store or transfer information input from the terminals, and to perform operations described in the present invention. In this case, the buyer may purchase finished product of the seller. The buyer may request product development by providing drawings and the like to a seller supplying products. At this time, information requirement level and procedure, security and the like between the buyer and the seller may vary depending on characteristics of the product, quantity, contract, business practices, information protection level, and the like. Hereinafter, a method with which the buyer selects a product supplying seller among multiple sellers will be mainly described.

The buyer terminal 100 and the seller terminals 200 transmit respective basic disclosed information to the server 300. At this time, the server 300 does not force the basic disclosed to be in a unified form. Therefore, the buyers and sellers can freely upload their files which they already have had, without intentionally modifying or re-writing information included in the file about company introduction and basic information.

In the specification, the basic disclosed information may include at least one of information described in the company introduction or a company website, such as company history, company policy, organization chart, equipment status, major items, and major customers. According to an embodiment, the basic information of the buyer may include a type of industry and main items. Additionally, the basic information of the seller may further include least one of information on a type of industry, location information, information on manufacturable products, current status information of equipments, customer information, or organization information of the seller.

The server 300 may disclose the basic disclosed public information according to a predetermined format, and the buyer terminal 100 may select candidate sellers to be evaluated based on the basic disclosed information of the sellers. For example, the buyer may select only three sellers as candidate sellers in order to perform technical evaluation of the three sellers based on the basic disclosed information provided by four sellers.

In the specification, the candidate seller refers to at least one seller for which the buyer intends to conduct a technical evaluation based on the basic disclosed information of the sellers in order to select a cooperate company or a seller. On the other hand, seller evaluation may be conducted in a tender method. At this time, the buyer can check information, such as the size of the seller, company location, and the customers with which the seller had business relations in the past, and then select the sellers that will be invited to participate in the tender as candidate sellers.

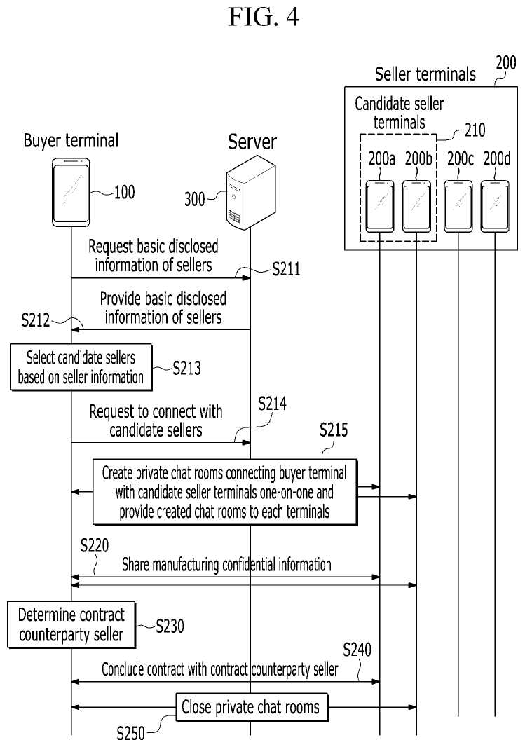

Meanwhile, various methods for selecting candidate sellers may be used and the methods will be described in detail with reference to FIG. 4 to FIG. 6.

When the buyer selects the candidate sellers by itself, the buyer terminal 100 transmits a connection request for performing the evaluation of the candidate sellers to the server 300.

Upon receiving the connection request, the server 300 provides a private chat room interface to each terminal so that evaluation and selection via the buyer terminal 100 and candidate seller terminals 210 can be performed.

For example, when the evaluation is conducted in a tender method, the buyer terminal 100 posts a tender notice through the provided private chat room, and shares manufacturing confidential information with the candidate sellers participating in the tender. After the tender deadline is over, the buyer can select the contract counterparty seller based on the shared information. Then, the procedure is completed after the buyer concludes the contract with the contract counterparty seller.

Meanwhile, the manufacturing confidential information shared through the private chat room may include at least one of a check sheet file used by the buyer for evaluating a seller, a check sheet file prepared by a seller, non-disclosure agreement (NDA) and memorandum of understanding (MOU) shared during a contracting procedure, detailed drawings and specifications of a product to be mass-produced actually, a seller estimate, and information about manufacturing concept of the buyer, sales volume of the seller, credit rating, process setup status, development and quality control status, and the like.

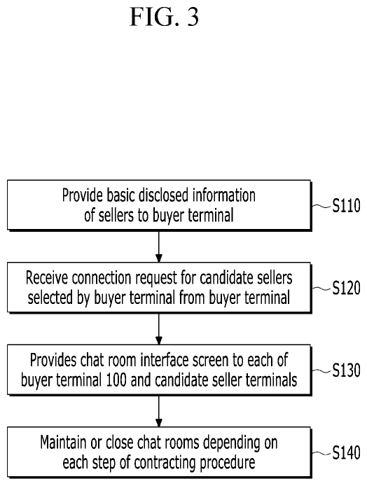

FIG. 3 is a flowchart showing a method for operating a server according to an embodiment.

Referring to FIG. 3, a server 300 provides basic disclosed information of sellers to a buyer terminal 100 accessing the server 300 (S110). Since the basic disclosed information has been described in detail with reference to FIG. 2, a detailed description of the information will be omitted.

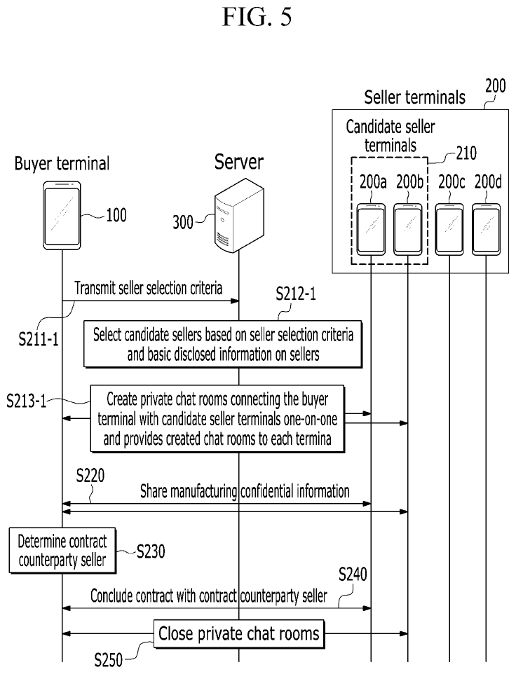

Thereafter, the server 300 receives a connection request for candidate sellers selected by the buyer terminal 100 from the buyer terminal 100 (S120). At this time, various methods may be used for selecting candidate sellers. The seller may select the candidate sellers based on the basic disclosed information of the sellers by itself. Further, the server 300 may receive selection criteria predetermined by the buyer, select plural candidate sellers satisfying the selection criteria based on the basic disclosed information of multiple sellers, and provide the selected candidate sellers to the buyer terminal 100. This process will be described with reference to FIG. 5.

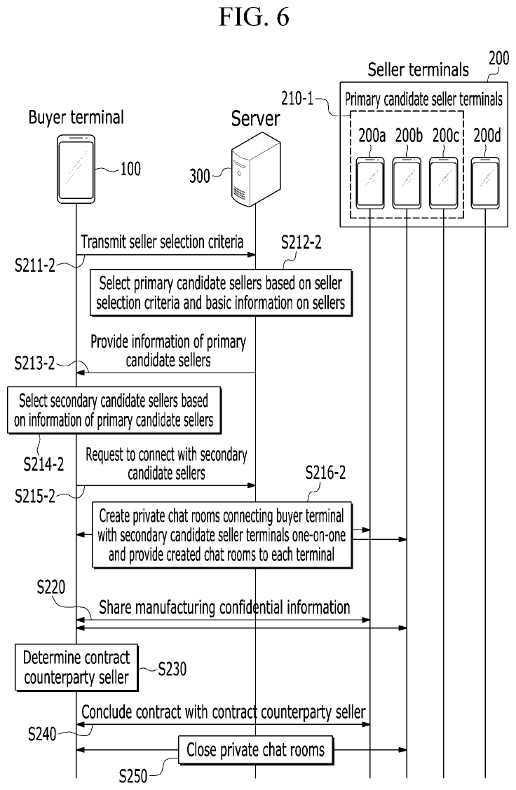

In addition, the server 300 may select primary candidate sellers based on the seller selection criteria and the basic disclosed information of the sellers, and provide the selected sellers to the buyer terminal 100 so that the buyer can directly select secondary candidate sellers. This process will be described in detail with reference to FIG. 6.

In this case, the seller selection criteria may include contents of the check sheet file of the buyer. The check sheet file may include the location of the seller, the sales volume of the seller, credit rating, whether there is a quality certificate, and information on licenses, approvals, patents, and the like granted to the seller.

The server 300 provides an interface screen of a private chat room which enables to perform the evaluation for seller selection and contracting after the selection, to each of the buyer terminal 100 and the selected candidate seller terminals 210 (S130).

For example, when the buyer selects a first seller, a second seller, and a third seller as the candidate sellers, the server 300 creates three private chat rooms on the buyer terminal 100 and one private chat room on each seller terminal 210 of the three candidate sellers.

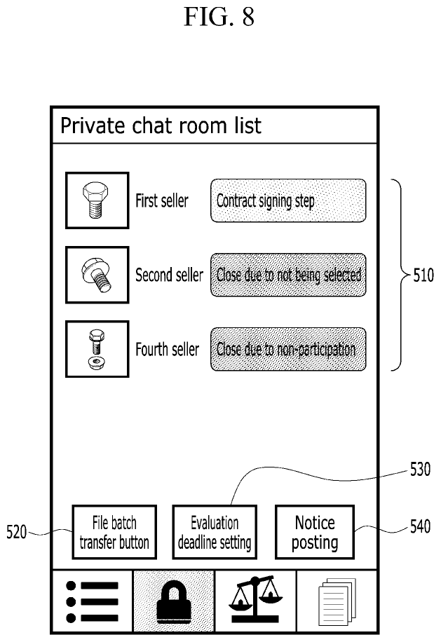

Meanwhile, the server 300 may sort one or more private chat rooms provided to the buyer terminal 100 according to predetermined criteria. Details will be described with reference to FIG. 8.

The server 300 provides additional functions so that all subsequent process, such as seller evaluation, selection, and contracting, can be performed via the chat room interface. For example, when the evaluation and selection are conducted in a tender method, the additional functions may include a function that supports initiating the tender through posting a tender notice with a predetermined deadline on all private chat rooms by the buyer, a function that allows the candidates sellers to participate in the tender by submitting a tender participation form through the chat room, a function that blocks uploading documents related to the tender after the deadline is over, a function that supports signing a contract with a seller determined as a contract counterparty seller and sharing the signed contract, and the like.

The server 300 maintains or closes the created private chat rooms depending on each step of the contracting procedure set by the buyer terminal 100 (S140).

The server 300 maintains the chat room connecting the buyer terminal 100 with the seller terminal of the contract counterparty seller so that the shared files can be read or a video conference can be conducted. The server 300 deactivates or closes the private chat rooms connected to the terminals of the candidate sellers which had not submitted required documents within the evaluation deadline or had participated in the evaluation but were not selected as the contract counterparty.

Meanwhile, the server 300 may store the manufacturing confidential information including drawing files, estimates, contracts, and the like shared between the buyer and the contract counterparty seller via the chat room and manage the stored information. At this time, the manufacturing confidential information of the candidate sellers that were not selected as the contract counterparty seller may be permanently deleted at the same time as the chat room is closed for security.

If the buyer intends to conclude a new contract after completing one contract, the server 300 may restart from step S110. In addition, when the buyer terminal 100 executes a plurality of contracts simultaneously, the server 300 may provide the buyer terminal 100 with a chat room list sorted according to events.

FIG. 4 is a flowchart showing a method for concluding a contract through a manufacturing and distribution platform according to an embodiment.

Referring to FIG. 4, a buyer terminal 100 requests basic disclosed information of sellers from a server 300 (S211). The buyers and sellers may upload company introduction files to the server in advance, and request information on other parties from the server.

The server 300 provides the basic disclosed information of the sellers to the connected buyer terminal 100 (S212). For example, the server 300 may allow the buyer terminal 100 and the seller terminals 200 to browse the basic disclosed information by uploading the basic disclosed information of the buyer and the sellers to a predetermined website in a readable format. The basic disclosed information of the sellers can be freely read via the buyer terminal 100 without a security check procedure.

The buyer terminal 100 selects candidate sellers for evaluation and selection based on the provided information on the sellers (S213). In the specification, the evaluation may refer to a tender process conducted publicly or an internal evaluation phase conducted privately. Meanwhile, the buyer may select only two sellers among four sellers as to be evaluated.

The buyer terminal 100 sends a connection request with candidate seller terminals 210 to the server 300 in order to initiate the evaluation procedure (S214). For example, when the evaluation is conducted in a tender method, the buyer may prepare a tender notice having a tender deadline and send a connection request to the server 300 in order to transmit the notice to the candidate seller terminals 210.

The server 300 creates private chat rooms that allow one-on-one connection between the buyer terminal 100 and each of the candidate seller terminals 210, and provides the created chat rooms to each of the candidate seller terminals 210 (S215). In this case, the buyer terminal 100 is provided with two chat rooms and the seller terminals 200a and 200b are provided with one chat room, respectively.

On the other hand, in order to strengthen the security of the private chat rooms, the server 300 may assign a dedicated ID and password to each of the private chat rooms and check the authority whenever the chat room is accessed. In another example, by setting a password on the file shared through the private chat rooms, a person who does not participate in the chat room or is irrelevant to a task is prohibited from browsing or downloading the shared files.

Meanwhile, the server 300 may receive information related to the evaluation from the buyer terminal 100, post the received information in all private chat rooms, and provide functions required for performing the contracting procedure, such as conversation function and file transfer function, through the private chat room. The information related to the evaluation includes a supplier selection checklist and evaluation guidelines prepared by the buyer to select a seller. The checklist and the guidelines include a technical evaluation sheet for proposals, service details, a delivery deadline, a technical evaluation procedure, a company registration deadline, and the like.

The buyer terminal 100 shares manufacturing confidential information with the candidate seller terminals 210 through the provided private chat room interface (S220). Here, the manufacturing confidential information may include a tender participation form when the evaluation is conducted in a tender method. When general supplier selection method is used, the manufacturing confidential information refers to information including a technical evaluation sheet, a quotation, a non-disclosure agreement, and the like. Since the information is described in detail with reference to FIG. 2, a detailed description will be omitted.

The buyer terminal 100 determines a contract counterparty seller 200a by evaluating the candidate sellers after the evaluation deadline is over (S230). For example, the buyer may evaluate 200a and 200b, decide to progress the contracting procedure with 200a, and select 200a as the contract counterparty seller.

At this time, the contract counterparty seller may be a seller determined as the most suitable seller through comprehensive evaluation of manufacturing performance capability and the like, a seller which proposed the lowest price in the quotation during the tender procedure, or a seller determined through a lottery conducted by the server 300.

On the other hand, the contract counterparty seller is the counterparty with which the buyer intends to conclude a contract. In the specification, it is assumed that the contract counterparty seller is one seller but may be two or more sellers situationally.

The buyer terminal 100 concludes a contract with the contract counterparty seller 200a that has passed through the evaluation and selection steps via the private chat room interface (S240).

On the other hand, the server 300 maintains the chat room with the contract counterparty seller 200a, and closes the chat room with the unselected seller 200b (S250).

FIG. 5 and FIG. 6 are flowcharts showing a method for concluding a contract through a manufacturing and distribution platform according to another embodiment. FIG. 5 shows a case in which a server selects candidate sellers. FIG. 6 shows a case in which the server selects primary candidate sellers and then a buyer selects secondary candidate sellers.

Referring to FIG. 5, a buyer terminal 100 transmits seller selection criteria prepared in advance to a server 300 (S211-1). The buyer has the seller selection criteria which is prepared based on previous contracting experiences or suitable for the characteristics of the buyer, and upload the criteria to the server 300.

Thereafter, the server 300 selects candidate sellers suitable for the buyer based on the seller selection criteria received from the buyer terminal 100 and basic information on sellers uploaded by the sellers (S212-1). For example, when the basic disclosed information of 200a and 200b satisfies the seller selection criteria, the server 300 may select 200a and 200b as candidate sellers.

After selecting the candidate sellers, the server 300 creates private chat rooms connecting the buyer terminal and each of the candidate seller terminals one-on-one and provides the chat rooms to each terminal (S213-1). For example, two chat rooms are created on the buyer terminal 100, one chat room is created on each of the candidate seller terminals 200a and 200b, and no chat room is created on 200c and 200d that are not selected as the candidate sellers.

After the private chat rooms are created, a step (S220) of sharing manufacturing confidential information for seller evaluation and selection by the buyer and subsequent steps (S230 to S250) are performed in the same way as shown in FIG. 4. Thus, a detailed description thereof will be omitted.

Referring to FIG. 6, a buyer terminal 100 transmits a seller selection criteria file to a server 300 (S211-2). This step is performed in the same way as shown in FIG. 5.

Thereafter, the server 300 selects primary candidate sellers determined to be suitable for a buyer based on the seller selection criteria file received from the buyer terminal 100 and basic information on sellers uploaded by the sellers (S212-2). That is, in the embodiment shown in FIG. 6, the server 300 does not determine candidate sellers through selection but the server provides the buyer with the candidate sellers, so that the buyer can determine the candidate sellers, unlike the embodiment shown in FIG. 5.

The server 300 provides a list of the selected primary candidate sellers and information thereof to the buyer terminal 100 (S213-2). In this case, the server 300 may provide the items of the seller selection criteria based on which the primary candidate sellers are selected, and basic information on the sellers satisfying the items.

Thereafter, the buyer terminal 100 selects secondary candidate sellers for which the evaluation step will be performed, among the primary candidate sellers selected by the server 300 (S214-2). For example, the server 300 may select 200a, 200b, and 200c as primary candidate sellers, and then the buyer may select only 200a and 200b as secondary candidate sellers.

The buyer terminal 100 transmits a request to connect with secondary candidate sellers to the server 300 (S215-2). This is similar to a procedure through which the buyer directly selects candidate sellers in FIG. 4.

Thereafter, the server 300 creates private chat rooms connecting the buyer terminal and each of the secondary candidate seller terminals one-on-one, and provides the created chat rooms to each terminal (S216-2). For example, one chat room is provided for 200a and 200b, and no chat room is created for 200c not selected as the secondary candidate seller. Two chat rooms are created and then provided to the buyer terminal 100.

The step (S220) of sharing the manufacturing confidential information for seller evaluation by the buyer after creating the private chat rooms, and subsequent steps (S230 to S250) are performed in the same way as shown in FIG. 4. Thus, a detailed description thereof will be omitted.

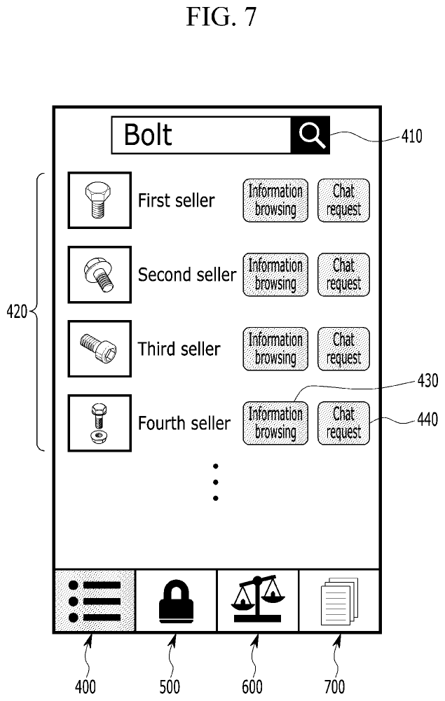

FIG. 7 is an example diagram of a seller search screen displayed on a buyer terminal according to an embodiment.

Referring to FIG. 7, a screen displayed on a buyer terminal 100 is equipped with four tabs. The four tabs are a search tab 400, a private chat room tab 500, a comparison tab 600, and a file tab 700, respectively, of which descriptions will be followed one by one.

The search tab 400 is an interface through which a buyer can search for any product. When a product desired to be manufactured is put in the search box 410 through the buyer terminal 100, the server 300 provides a suitable seller list 420 based on basic disclosed information of the sellers.

In addition, the buyer can browse the basic public information uploaded by sellers to the server 300 by clicking an information browsing button 430 and can send a connection request to the server by clicking a chat request button 440 in order to select candidate sellers.

The private chat room tab 500 is an interface where the private chat rooms provided from the server 300 are sorted, and details thereof will be described with reference to FIG. 8 to FIG. 11.

The comparison tab 600 is an interface enabling to make a comparison among basic disclosed information of multiple sellers at a glance. When one or more sellers are selected from the seller list 420 via the buyer terminal 100, the server 300 may arrange the basic disclosed information of sellers in a row. As a result, the buyer can compare and understand the basic disclosed information of the multiple sellers at a glance.

The file tab 700 is an interface through which the buyer terminal 100 or the seller terminals 200 can upload the basic disclosed information to the server 300. Since there is no limit to a file format that can be uploaded to the server 300, the buyer and seller can freely upload existing files, such as a company introduction file, needless to rewrite existing information to fit for a new format.

FIG. 8 is an example diagram of a screen showing a private chat room list displayed on a buyer terminal according to an embodiment.

When a private chat room tab 500 is clicked, a private chat room list 510 is displayed. Here, the private chat room list 510 refers to a list of sellers that are selected as candidate sellers among the sellers found via the search tab 400 and with which the buyer terminal 100 transmits a request to connect to the server 300.

On the other hand, the private chat room list 510 may be sorted according to predetermined criteria. For example, seller selection criteria transmitted from the buyer and basic disclosed information files of the sellers may be used as sorting criteria. The server 300 may give scores to the sellers according to a degree to which the capability of the seller matches items of the selection criteria of the buyer. Since a seller that satisfies the largest number of manufacturing detailed items desired by the seller will get the highest score, the chat room with this seller may be placed at the top of the private chat room list 510.

In the private chat room list 510, each chat room may be displayed distinctively depending on which step the buyer and each candidate seller are conducting among the steps of the contract procedure. For example, the chat room with a first seller may be displayed in anyone color with a notice of ‘Contract signing step’, and the chat rooms with a second seller and a fourth seller will be displayed in a different color with a notice of ‘Close’.

When a file batch transfer button 520 is clicked, the server 300 may transmit files at one time to the private chat rooms created on the buyer terminal 100. For example, the buyer can transmit the same file at once to all chat rooms by clicking the file batch transfer button 520 needless to transmit the file to the multiple chat rooms one by one, in order to post evaluation guidelines, a tender notice, a notice file, or a supplier selection checklist prepared to include items, such as a proposal technical evaluation sheet, service details, delivery deadline, technical evaluation procedure, and supplier registration period.

When an evaluation deadline setting button 530 is clicked, the buyer terminal 100 may set the evaluation deadline and perform the evaluation of the candidate sellers within the evaluation deadline. When the set evaluation deadline is over, the server 300 may inactivate the file upload function so that the candidate sellers can no longer submit documents required for the evaluation, thereby automatically filtering out candidate sellers who had not participated. On the other hand, when the evaluation is conducted in a tender method, the evaluation deadline may be the tender deadline.

When a notice posting button 540 is clicked, the server 300 may post the a notice prepared by the buyer on all private chat rooms at a time.

Hereinafter, a screen of a private chat room displayed on a terminal will be described as an example.

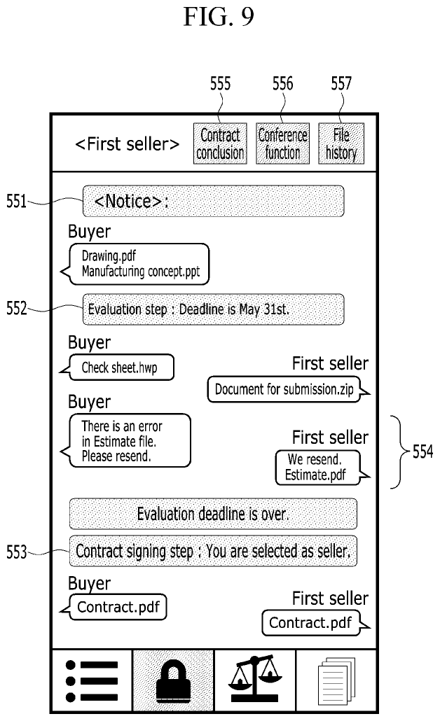

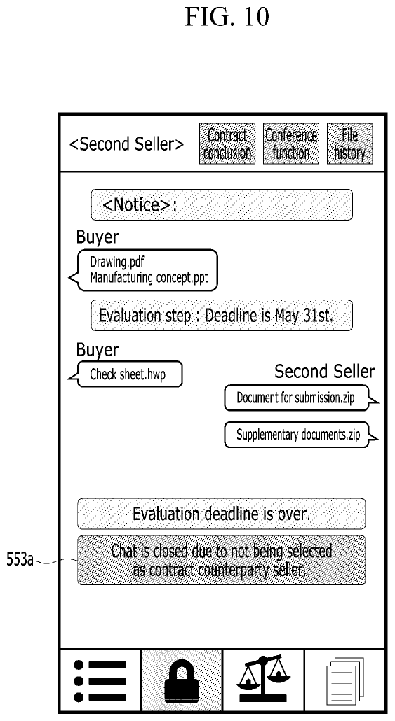

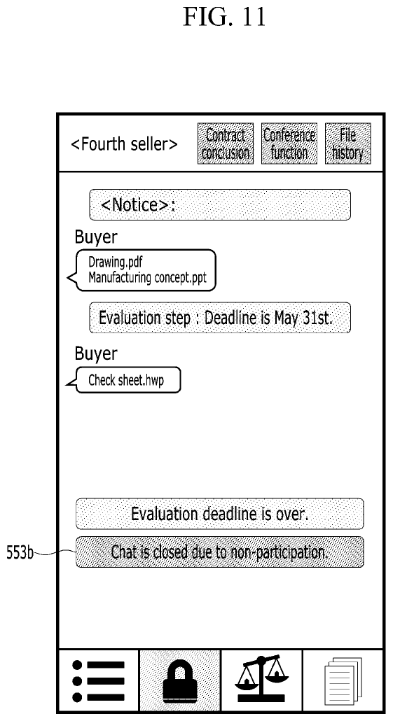

FIG. 9 is an example diagram of a screen showing a maintained private chat room according to an embodiment, FIG. 10 is an example diagram of a screen showing a private chat room that is closed due to not being selected as a seller according to an embodiment, and FIG. 11 is an example diagram of a screen showing a private chat room that is closed due to non-participation of a seller according to an embodiment.

Referring to FIG. 9, a notice notification window 551 is a space where a notice prepared by a buyer is displayed. The notification window 551 is displayed in all private chat rooms in the same way.

Contracting step notification windows 552 and 553 indicate which step of the contracting procedure is being conducted between the buyer and a seller participating in a chat room. In an evaluation step notification window 552, an evaluation deadline determined by the buyer using the evaluation deadline setting button 530 is displayed identically in all the private chat rooms. A contract signing step notification window 553 is not displayed in all private chat rooms but displayed only in a chat room with a seller, being a contract counterparty seller.

For example, when a first seller is selected as the contract counterparty seller, the contract signing step notification window 553 is displayed on the chat room with the first seller. After the notification window is displayed, the buyer and the contract counterparty seller conclude the contract by signing the contract and sharing the signed contract.

On the other hand, the chat room interface provides a conversation function 554 between chat room participants. This function can be used not only in a chat room with the contract counterparty seller but also in all private chat rooms. Through real-time communication in the chat room, the buyer and the sellers can easily request, require, and the like.

Additionally, the buyer terminal 100 and the candidate seller terminals 210 can share files through the conversation function. Since there is no limit to a file format, files, such as various documents, videos, and photos, can be freely uploaded and a voice recording file can be shared via voice recording function (not shown).

The voice recording function is to response to a case where time difference makes real-time communication difficult when the buyer or the seller is abroad. After a simple message is saved through voice recording, a buyer or a seller, being a recipient, can easily check the message at the start of the work and then reflect the details of the message in the work.

Here, a list of files shared in the chat room can be checked by pressing a file history button 557. Even if a person in charge of the buyer-side or the seller-side changes, this function allows the new person in charge to understand the work quickly, thereby facilitating the progress of the project.

The buyer may determine the contract counterparty seller by clicking a contract conclusion button 555. All private chat rooms provided to the buyer terminal 100 is equipped with the contract conclusion button 555, and the server 300 activates the button as soon as the evaluation deadline is over. When the evaluation deadline is over and the buyer presses the contract conclusion button 555 in the chat room with a seller with which the buyer will conclude the contract, the seller, being a participant in the corresponding chat room, is determined as the contract counterparty seller. At this time, the server 300 automatically deactivates the contract conclusion button 555 equipped in the remaining chat rooms.

The specification describes a case where only one contract counterparty seller exists. When two or more sellers can be selected as the contract counterparty according to the features of the contract, the contract conclusion button 555 may be activated in two or more chat rooms.

By clicking a conference function button 556, the buyer terminal 100 and the candidate seller terminals 210 can conduct a video conference or a remote drawing conference.

Due to the characteristics of the manufacturing industry, there is a limit for the buyer and the seller to communicate only via phone calls or e-mails. Since the buyer and the seller should communicate based on the drawings and products to communicate accurately, the server 300 provides a function that allows the buyer and the seller to see that drawings or products is designed or revised in real-time while conducting the remote conference.

Referring to FIG. 10, the server 300 closes a chat room with a seller that is not selected as the contract counterparty seller and a chat closing window 553a is displayed on the chat room screen.

In a case where the buyer selected a second seller as a seller to be evaluated and performed the evaluation based on documents submitted by the second seller but did not determine the second seller as the final contract counterparty seller, the chat closing window 553a is displayed along with a notice that the seller is not selected as the final contract counterparty seller.

Meanwhile, when the chat room is closed, the server 300 inactivates the contract conclusion button 555, the conference function button 556, and the file history button 557 for security.

Referring to FIG. 11, the server 300 closes the chat room with a seller who had not submitted documents within an evaluation deadline, and a chat closing window 553b is displayed on a chat room screen.

For example, the chat closing window 553b is displayed with a message notifying that a fourth seller did not participate because the fourth seller did not submit documents within the evaluation deadline set by the buyer despite being selected as to be evaluated by the buyer.

In the specification, it is described that an evaluation procedure for selecting a supplier is performed on a manufacturing and distribution system and it is assumed that selective tendering or limited tendering exemplifies a way of an evaluation for concluding a contract. However, a system of the present invention might well be applied to a case where an open tendering that allows all sellers to participate in tendering by sharing manufacturing confidential information with a buyer is used for concluding a contract.

According to the present invention, a buyer and a seller can safely share and manage manufacturing confidential information of which security is essential. In addition, the buyer can check and compare the characteristics and quotations of multiple sellers without any inconvenience of inquiring the multiple sellers one-on-one, and can perform processes from seller evaluation to contract conclusion on a single platform.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

1. A method for providing by a server a manufacturing and distribution platform connecting a product buyer and a product seller, the method comprising:
providing basic disclosed information of multiple sellers to an accessing buyer terminal;
receiving a connection request for candidate sellers selected by the buyer terminal among the multiple sellers; and
providing an interface screen of a private chat room which allows the buyer terminal and each candidate seller terminal to exchange manufacturing confidential information related to a product and a company,
wherein the private chat room connects the buyer terminal and the candidate sellers one-on-one, and each private chat room provided to each of the candidate sellers is maintained or closed according to each step of a contracting procedure set by the buyer terminal.

2. The method of claim 1, wherein, after providing the interface screen of the private chat room, the server receives information related to evaluation including a supplier selection check sheet and an evaluation deadline, creates an evaluation step notification window on the interface of the private chat room, and blocks file uploading by the candidate seller terminal and activates a contract signing button when the evaluation deadline is over.

3. The method of claim 2, wherein, when the buyer terminal selects a contract counterparty seller and concludes a contract, the server creates a contract signing step notification window on a private chat room with the contract counterparty seller, maintains only the private chat room with the contract counterparty seller, and closes remaining private chat rooms by inactivating functions of the remaining private chat rooms.

4. The method of claim 2, wherein the server transmits the information related to the evaluation and notices received from the buyer terminal to all private chat rooms created on the buyer terminal at a time.

5. The method of claim 1, wherein the server provides a video conference interface or remote drawing conference interface through the interface screen of the private chat room.

6. A method for providing by a server a manufacturing and distribution platform connecting a product buyer and a product seller, the method comprising:
receiving seller selection criteria from a buyer terminal;
selecting candidate sellers among multiple sellers based on the seller selection criteria and basic disclosed information of the multiple sellers; and
providing an interface screen of a private chat room which allows the buyer terminal and each candidate seller terminal to exchange manufacturing confidential information related to a product and a company,
wherein the private chat room connects the buyer terminal and the candidate sellers one-on-one, and each private chat room provided to each of the candidate sellers is maintained or closed according to each step of a contracting procedure set by the buyer terminal.

7. The method of claim 6, wherein providing the interface screen of the private chat room comprises giving a score to each candidate seller according to a degree to which the basic disclosed information of the candidate sellers matches the seller selection criteria, and arranging the private chat rooms created on the buyer terminal according to the given scores.

8. The method of claim 6, further comprising, after providing the interface screen of the private chat room, receiving evaluation information including a supplier selection check sheet and an evaluation deadline from the buyer terminal,
wherein the server inactivates functions of a chat room with a seller that did not submit materials within the evaluation deadline among the candidate sellers and closes the chat room.

9. The method of claim 6, wherein when the evaluation deadline is over and the buyer terminal selects a contract counterparty seller, the server maintains only a private chat room with the contract counterparty seller and closes remaining private chat rooms by inactivating functions of the remaining private chat rooms.

10. A method for providing by a server a manufacturing and distribution platform connecting a product buyer and a product seller, the method comprising:
receiving seller selection criteria from a buyer terminal;
selecting primary candidate sellers among multiple sellers based on the seller selection criteria and basic disclosed information of the multiple sellers;
providing information of the primary candidate sellers to the buyer terminal;
receiving a connection request with secondary candidate sellers selected by the buyer terminal among the primary candidate sellers; and
providing an interface screen of a private chat room that allows the buyer terminal and each of the secondary candidate sellers to exchange manufacturing confidential information related to a product and a company,
wherein the private chat room connects the buyer terminal with the secondary candidate sellers one-on-one, and each private chat room provided to each of the candidate sellers is maintained or closed according to each step of a contracting procedure set by the buyer terminal.

11. The method of claim 10, wherein providing the interface screen of the private chat room comprises giving a score to each of the secondary candidate sellers according to a degree to which the basic disclosed information of the secondary candidate sellers matches the seller selection criteria, and arranging the private chat rooms created on the buyer terminal according to the given scores.

12. The method of claim 10, wherein, after providing the interface screen of the private chat room, the server receives information related to an evaluation including a supplier selection check sheet and an evaluation period, and when the evaluation is over, the server maintains only a private chat room with the contract counterparty seller and closes remaining private chat rooms by in activating functions of the remaining private chat rooms.
